(19) United States
(12) Patent Application Publication
(10) Pub. No.: US 2006/0232610 A1
(43) Pub. Date: Oct. 19, 2006

(54) Display device

(75) Inventors: Jin-ho Lee, Suwon-si (KR); Byoung-Iyong Choi, Seoul (KR); Yong-kweun Mun, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/404,927

(22) Filed: Apr. 17, 2006

(30) Foreign Application Priority Data
Apr. 15, 2005 (KR) 10-2005-0031405

(51) Int. Cl. G09G 5/00

(52) U.S. Cl. 345/660

(57) ABSTRACT

A display device includes a handset having a display window on which an image is displayed, a projection unit included in the handset and enlarging an image and projecting the enlarged image, and a screen movably installed on the handset and displaying the enlarged and projected image thereon. In the display device, an image that the handset displays is displayed on the screen that is larger than the display window of the handset. Thus, various contents such as Internet search or movie can be viewed through an enlarged screen of a mobile handset with more convenience and sense of liveliness. Furthermore, the display device can enlarge an image and project the enlarged image onto a screen for a long time by using a laser scanning method that exhibits a superior optical efficiency and a low power consumption.

### CROSS-REFERENCE TO RELATED PATENT APPLICATIONS

This application claims priority from Korean Patent Application No. 10-2005-0031405, filed on Apr. 15, 2005, in the Korean Intellectual Property Office, the disclosure of which is incorporated herein in its entirety by reference.

### BACKGROUND OF THE INVENTION

1. Field of the Invention

The present invention relates to a display device, and more particularly, to a display device capable of displaying an image on a screen provided in a handset by enlarging and projecting the image onto the screen so that a larger image than one displayed on a display window provided in the handset can be displayed.

2. Description of the Related Art

Recently, various types of handsets such as mobile phones, personal digital assistants (PDAs), MPEG Audio Layer 3 (MP3) players, compact disc (CD) players, and portable multimedia players (PMPs) are being used. In particular, the mobile phones, PDAs, and PMPs generally have a display function. For this purpose, the mobile phones and PDAs have a display window of a predetermined size so that users can view images and motion pictures such as movies through the display window. In view of recent technologies such as a digital multimedia broadcasting (DMB) service which enables users to enjoy broadcasting through a mobile phone, the display window is essential for the handset.

However, since the display window is provided in the handset, there is a limitation in the size of the display window. That is, the display window cannot be larger than the handset. Therefore, the users view the displayed image using the display window having a limited size so that the users' eyes become easily tired while viewing the images or motion pictures for a long time using the display window. The conventional portable display devices inconvenience the users due to the limited size of the display window in interfacing with the users.

### SUMMARY OF THE INVENTION

Illustrative, non-limiting embodiments of the present invention overcome the above disadvantages and other disadvantages not described above. Also, the present invention is not required to overcome the disadvantages described above, and an illustrative, non-limiting embodiment of the present invention may not overcome any of the problems described above.

The present invention provides a display device capable of displaying an image larger than a display window of a handset by enlarging and projecting the image onto a screen provided in the handset.

According to an aspect of the present invention, there is provided a display device includes a handset having a display window on which an image is displayed, a projection unit included in the handset and enlarging an image and projecting the enlarged image, and a screen detachably installed on the handset and displaying the enlarged and projected image thereon.

The screen may be provided by being wound around a roll installed at a side surface of the handset.

A hook may be formed at an end of the screen and a hole corresponding to the hook may be formed in the handset to locate the screen to face the projection unit.

The handset may comprise a screen accommodation portion in which the screen is accommodated to be capable of sliding in and out.

The display device may further include a driving portion instructing the handset to generate the image, and a screen drawing portion automatically drawing the screen from the screen accommodation portion.

The display device may further include a driving portion outputting a function performance instruction signal instructing the handset to perform a predetermined function, a monitoring portion monitoring whether the output function performance instruction signal instructs generation of the image, and a screen drawing portion automatically drawing the screen in response to the monitoring result from the screen accommodation portion.

The handset may selectively display the image on one of the display window and the screen.

According to another aspect of the present invention, there is provided a display device which includes a handset including a first folder portion having a display window on which an image is displayed and a second folder portion opening and closed with respect to the first folder portion, a screen detachably installed on the handset and having a size larger than the size of the display window, and a projection unit included in one of the first and second folder portions and enlarging the image and projecting the enlarged image onto the screen.

The screen may be provided by being wound around a roll installed at a side surface of the second folder portion.

A hook may be formed at an end of the screen and a hole corresponding to the hook may be formed in the first holder to locate the screen to face the projection unit.

The second folder portion may comprise a screen accommodation portion in which the screen is installed capable of sliding in and out.

### BRIEF DESCRIPTION OF THE DRAWINGS

The above and other aspects of the present invention will become more apparent by describing exemplary embodiments thereof with reference to the accompanying drawings in which:

FIGS. 1A through 1F are views for explaining a display device according to first and second exemplary embodiments of the present invention;

FIGS. 2A through 2E are views reference views for explaining a display device according to third through fifth exemplary embodiments of the present invention;

FIG. 3 is a block diagram for explaining a principle of automatic drawing of a screen in accordance with an exemplary embodiment of the present invention; and

FIG. 4 is a flow chart for explaining the principle of automatic drawing of a screen in accordance with an exemplary embodiment of the present invention.

### DETAILED DESCRIPTION OF THE INVENTION

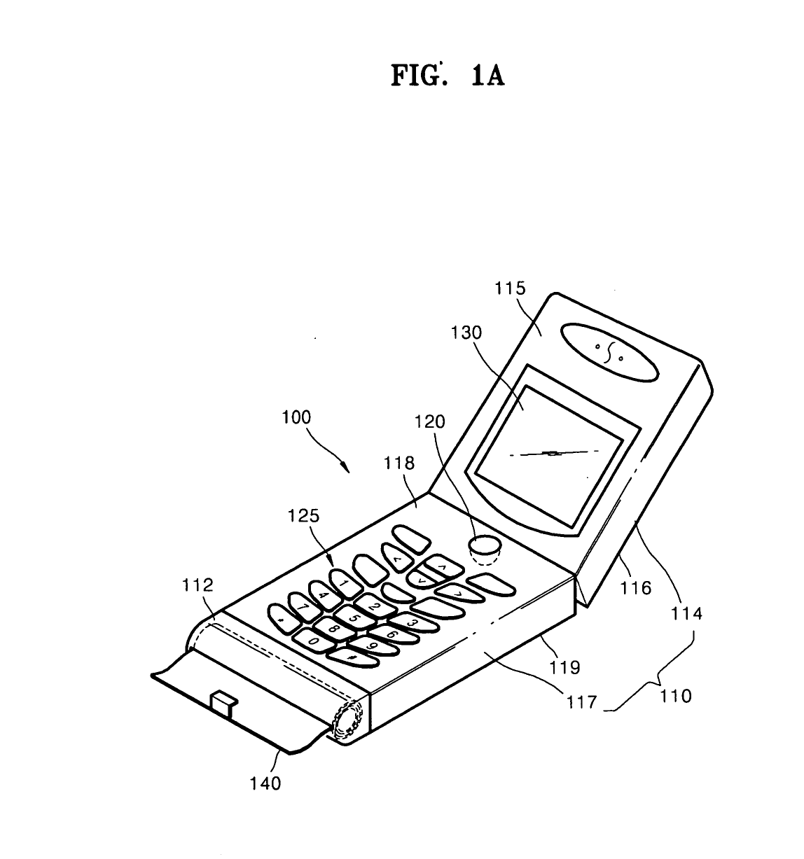

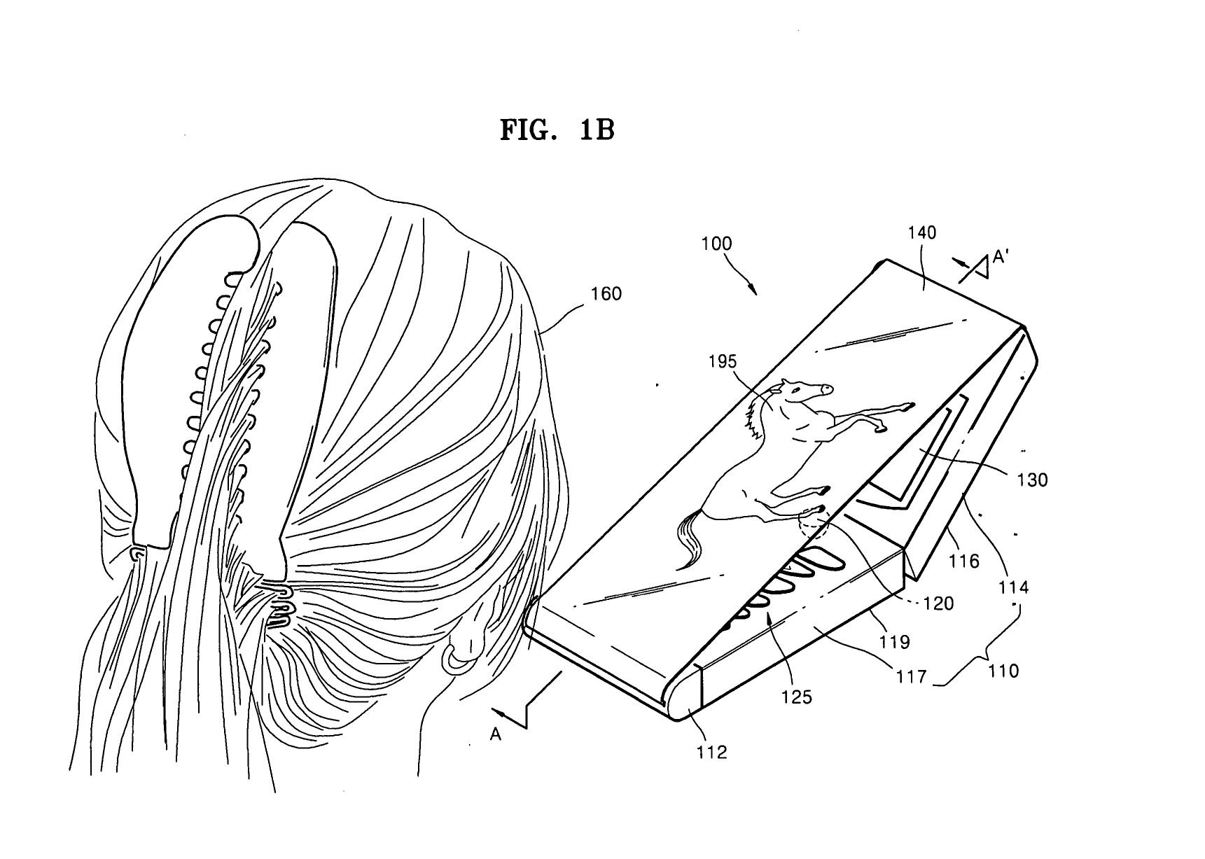

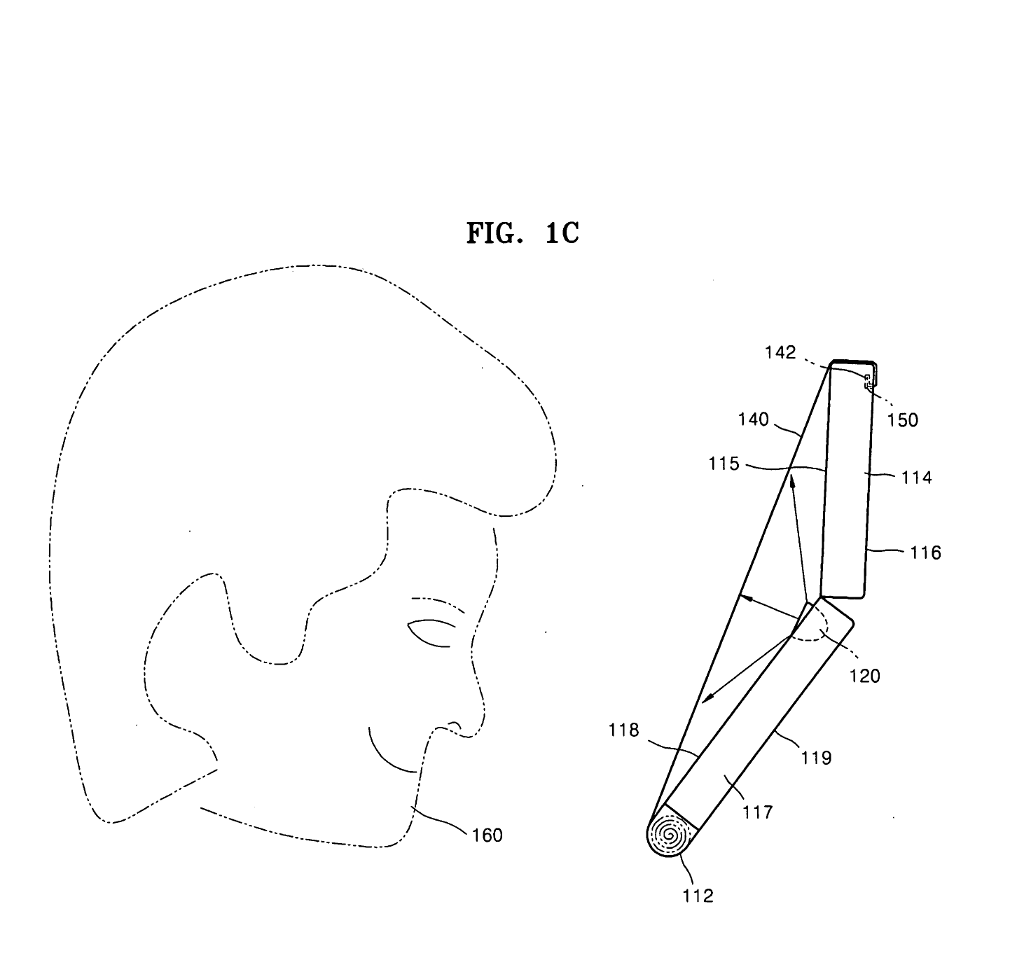

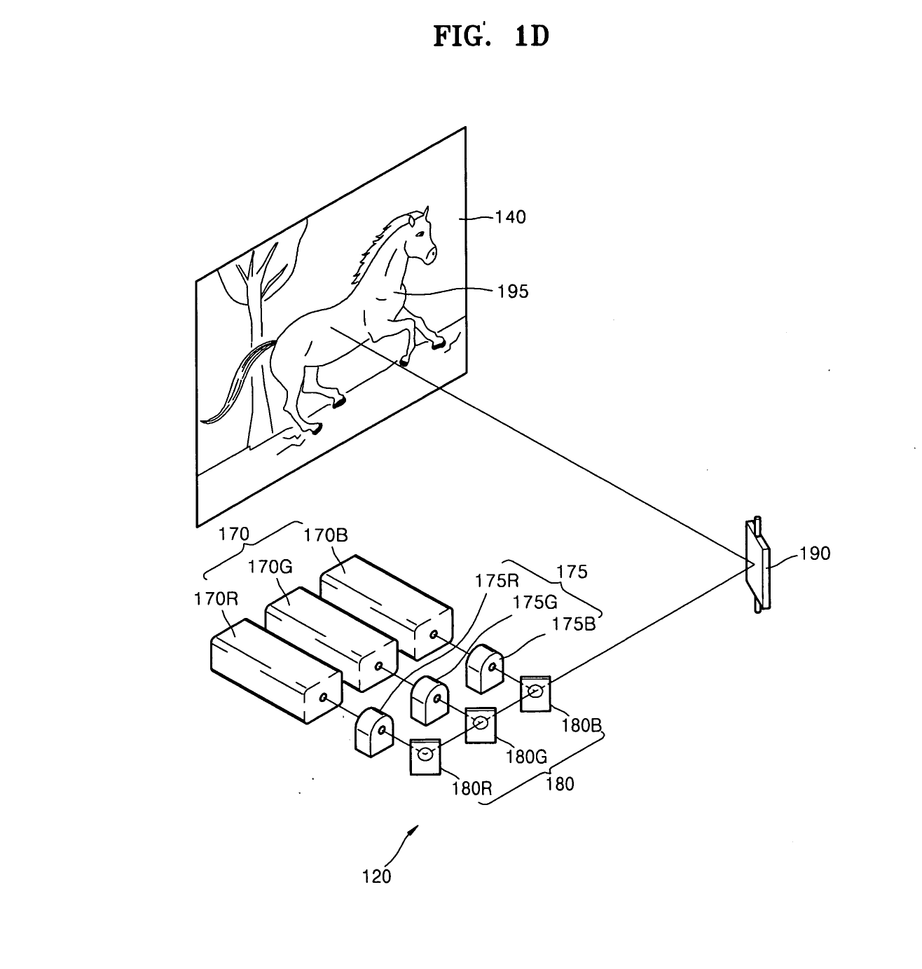

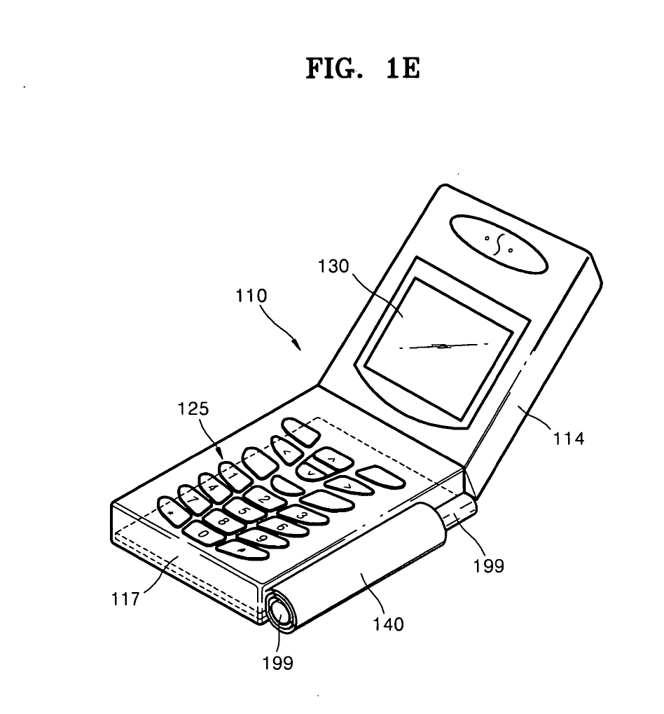

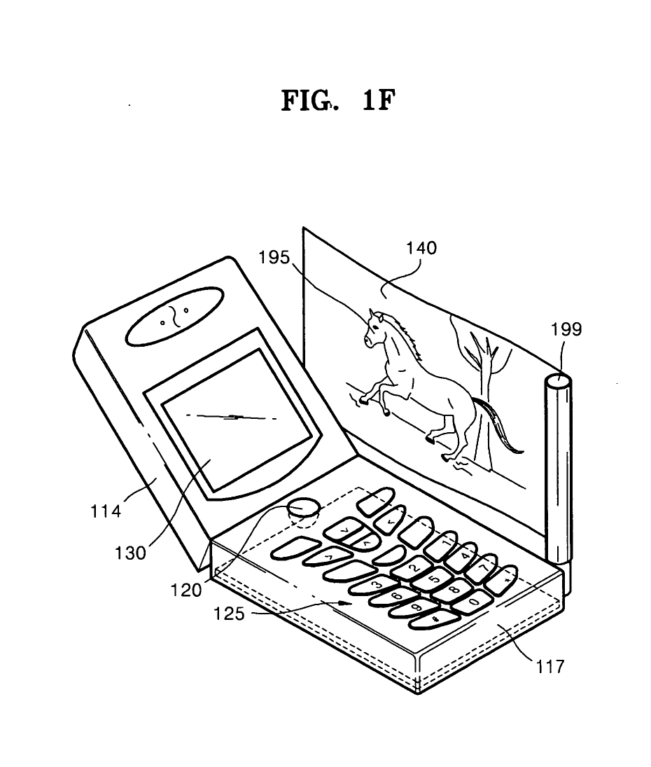

FIGS. 1A through 1F are views for explaining a display device according to first and second exemplary embodiments of the present invention. In detail, FIG. 1A is a perspective view of a display device 100 according to a first exemplary embodiment of the present invention. FIG. 1B is a perspective view showing a state in which the display device 100 of FIG. 1A is in use. FIG. 1C is a cross-sectional view taken along line A-A′ of FIG. 1B. FIG. 1D is a perspective view showing the interior structure of a projection unit 120. FIGS. 1E and 1F are views for explaining a display device according to second exemplary embodiments of the present invention. In detail, FIG. 1E is a perspective view of a display device 110 according to the second exemplary embodiment of the present invention. FIG. 1F is a perspective view showing a state in which the display device 110 of FIG. 1E is in use.

Referring to FIG. 1A, the display device 100 includes a handset 110 and a screen 140. The handset 110 may be a portable handset capable of displaying a predetermined image. The image may be a motion picture or a still image like a photograph. The hand set 110 may be a flip type mobile phone, a folder type mobile phone, a PDA, or a PMP. For the convenience of explanation, the handset 110 is assumed to be a folder type mobile phone.

The handset 110 includes a first folder portion 114 and a second folder portion 117. The first folder portion 114 has a front surface 115 and a rear surface 116 while the second folder portion 117 has a front surface 118 and a rear surface 119.

The handset 110 further includes a projection unit 120, a keypad 125, and a display window 130. The display window 130 provided in the first folder portion 114 displays a predetermined image. The keypad 125 provided in the second folder portion 117 is a user interface provided for a user to input an instruction to perform a predetermined function of the handset 110. The projection unit 120 included in either the first folder portion 114 or the second folder portion 117 enlarges and projects an image larger than that displayed on the display window 130, onto the screen 140.

As shown in FIGS. 1B and 1C, the screen 140 is detachably installed on the handset 110, on which an image enlarged and projected by the projection unit 120 is displayed. In detail, the screen 140 is installed in an accommodation portion 112 provided at a side end of the second folder portion 117 in form of being wound around a roll. For this purpose, like a roll, the screen 140 is wound around a rod (not shown) that is rotatably installed at the side end of the second folder portion 117 and the screen 140 may be drawn out by unwinding the roll.

An end of the screen 140 released from the accommodation portion 112 may be attached to the rear surface 116 of the first folder portion 114 so that an enlarged image 195 the to the rear surface 116 of the first folder portion 114 is provided at the rear surface 116 of the first folder portion 114 to face the projection unit 120. In detail, the fixing portion comprises a hole or recessed portion 150 formed in the rear surface 116 of the first folder portion 114. Further, a hook 142 is formed at an end of the screen so that when the hook 142 is inserted in the hole 150, the drawn screen 140 is fixed to the handset 110.

In the above exemplary embodiment, although the hook 142 and the hole 150 are provided to fix the screen 140 to the handset 110 in order to project an image onto the screen 140, the present invention is not limited thereto. For example, a magnet (not shown) may be provided at a position of the hole 150 instead of a hole while the screen 140 may include a magnet or may be covered with a magnetic material that is attracted by the magnet. Thus, when the end of the screen 140 is positioned near the magnet provided at the rear surface 116 of the first holder 114, the screen 140 is fixed to the handset 110 as the magnet or magnetic material of the screen 140 is attracted by the magnet. The screen 140 is installed at the handset 110 in a state in which both end portions of the screen 140 are tightened. As a result, as shown in FIG. 1C, a user 160 can view the enlarged image 195 that is larger than the display window 130 displayed on the screen 140.

Referring to FIG. 1D, the projection unit 120 includes a plurality of light sources 170 emitting monochromic light beams having different wavelengths, an optical modulator 175 modulating the monochromic light beams according to color signals, an optical combiner 180 combining the monochromic light beams modulated by the optical modulator 175 into a single light beam, and an optical scanner 190 scanning the light beam to form an image.

In another exemplary embodiment, the light source 170 may include first, second, and third lasers 170R, 170G, and 170B emitting three primary colors such as red R, green G, and blue B. The RGB rays emitted from the first, second, and third lasers 170R, 170G, and

The first, second, and third optical modulators 175R, 175G, and 175B optically modulate the RGB rays incident thereon. Then, the RGB rays modulated by the first, second, and third optical modulators 175R, 175G, and 175B are combined into a single light ray by first, second, and third dichroic mirrors 180R, 180G, and 180B which reflect light having a predetermined wavelength and transmit light having different wavelengths. That is, the first dichroic mirror 180R reflects a red light R and transmits light having different wavelengths. The second dichroic mirror 180G reflects a green light G and transmits light having different wavelengths. The third dichroic mirror 180B reflects a blue light B and transmits light having different wavelengths. The combined light is scanned toward the screen 140 by the optical scanner 190 so that the image 195 is formed on the screen 140.

When lasers capable of directly modulating light according to video signals are used, the above lasers 170R, 170G, and 170B can be removed. In forming an image, either two optical scanners for horizontal scanning and vertical scanning can be used or a single optical scanner capable of both horizontal and vertical scanning can be used. The optical scanner capable of both horizontal and vertical scanning has two axes.

The screen 140 may be a reflection type or a transmission type. In the present embodiment, a transmission type screen is shown. As shown in FIGS. 1E and 1F, the screen 140 can be provided by being wound around a bar 199 installed at a side surface of the second folder portion 117. One end of the screen 140 released from the bar 199 can be installed at the first folder portion 114. The projection unit 120 enlarges and projects the image 195 onto the screen 140.

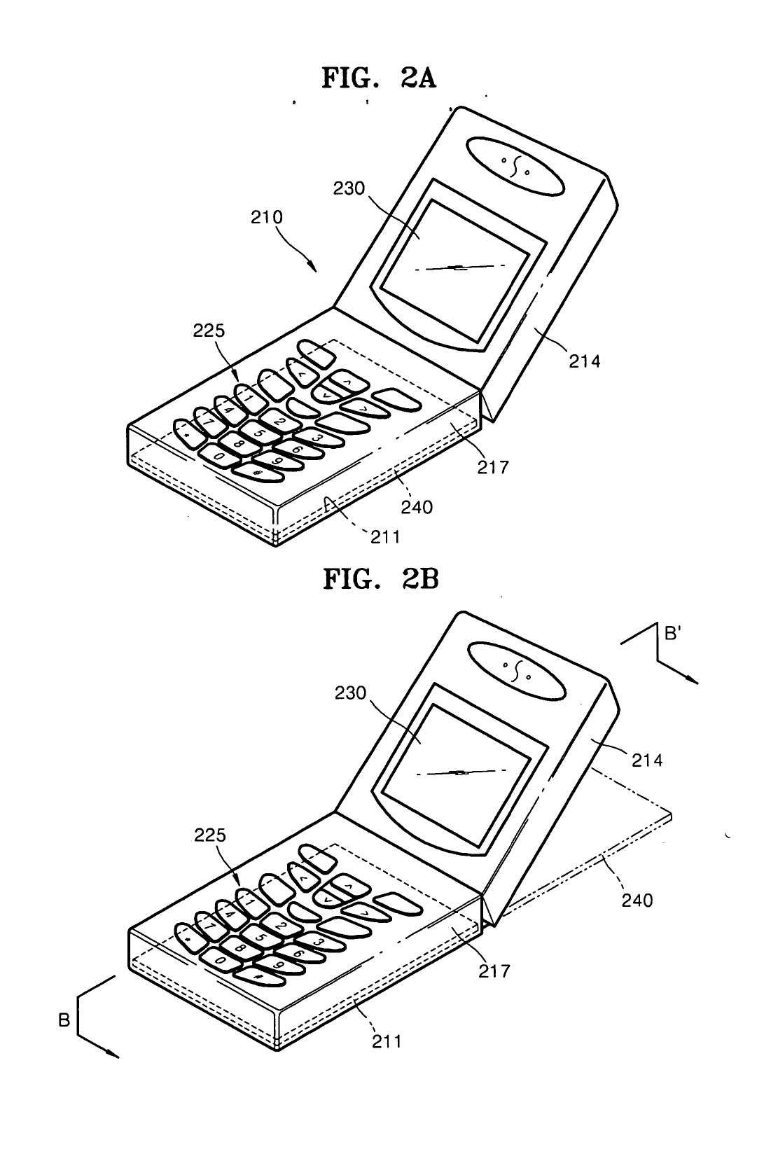

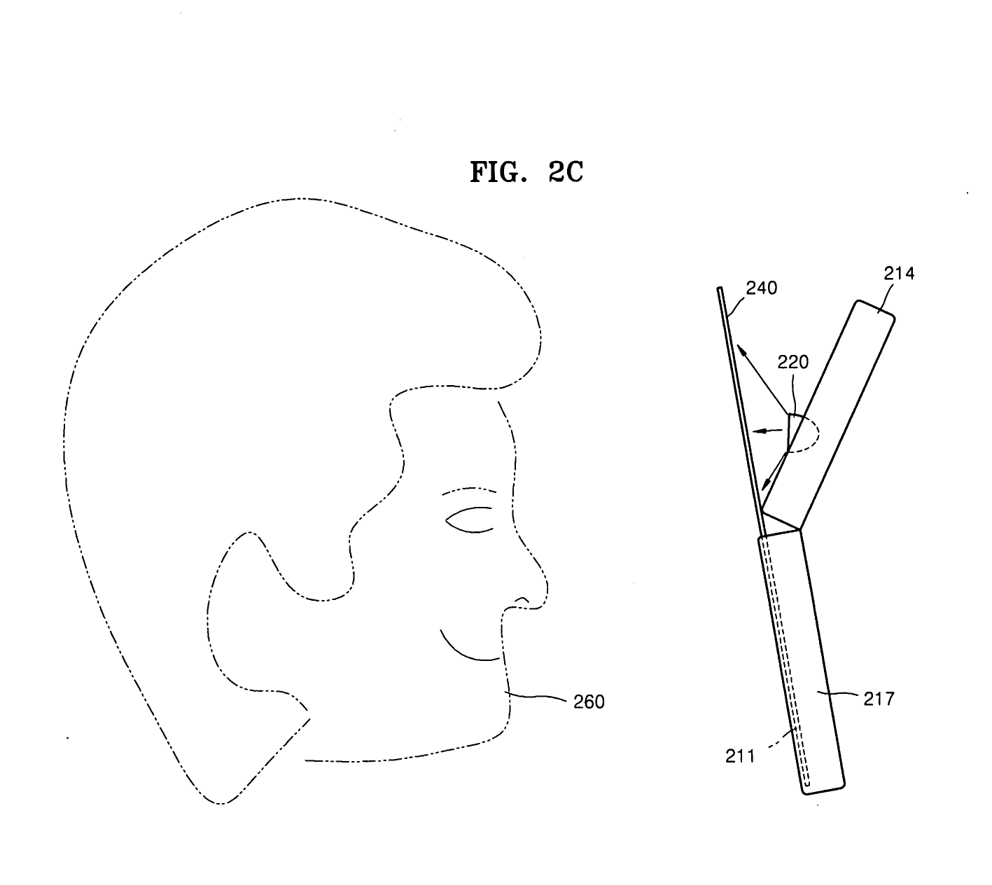

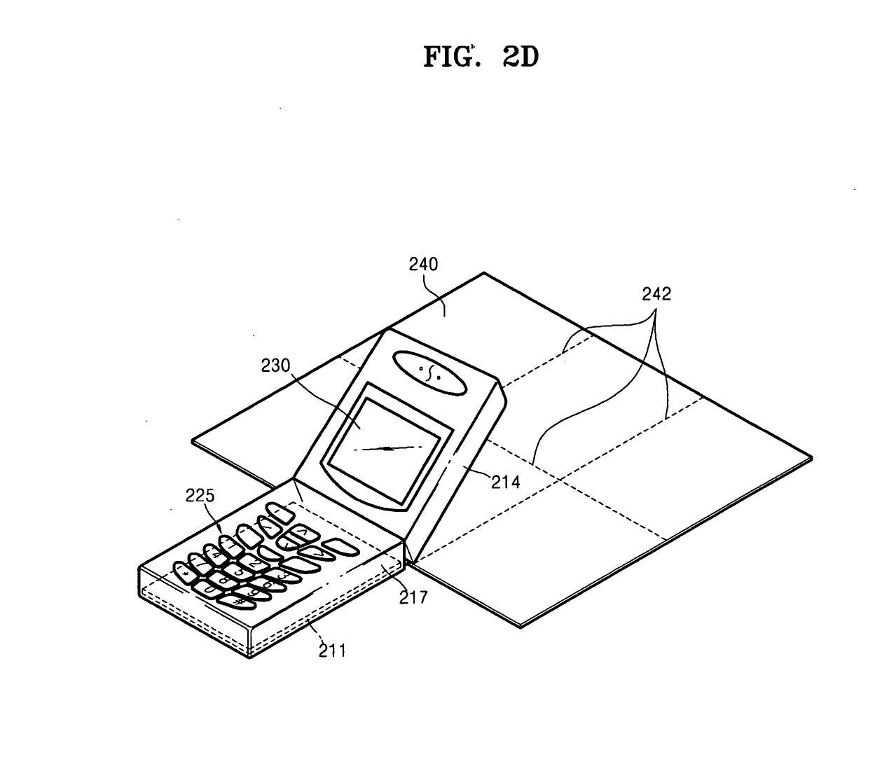

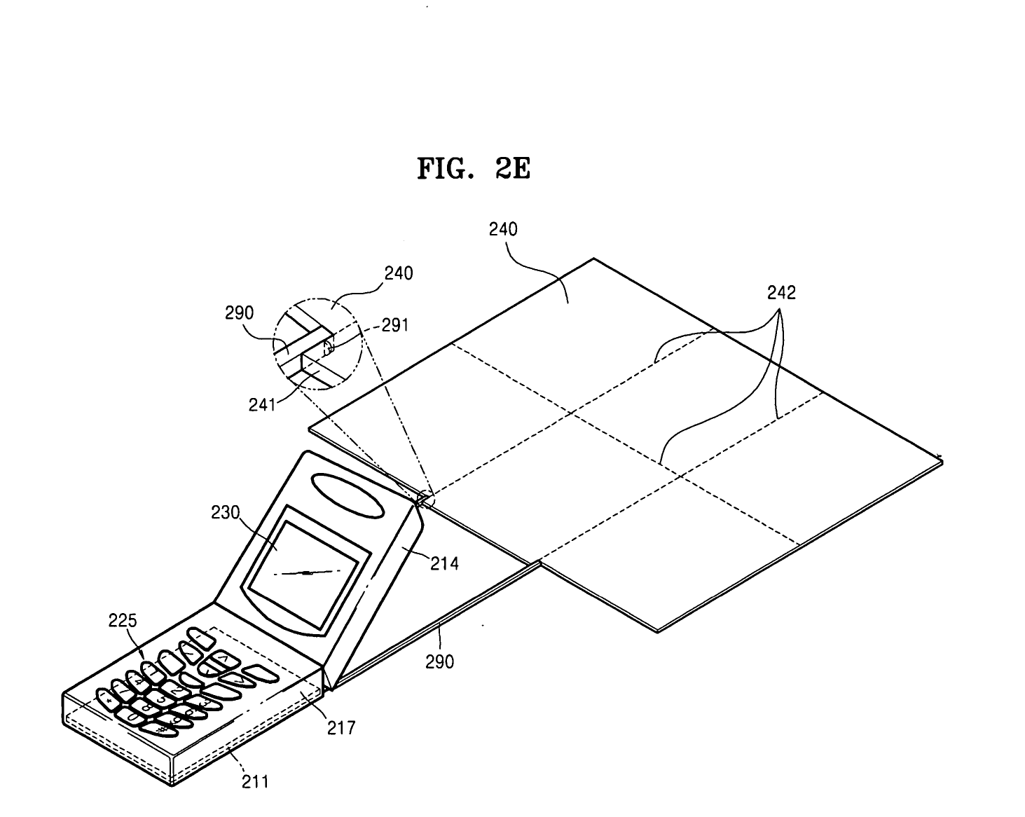

FIGS. 2A through 2C are views for explaining a display device according to a third exemplary embodiment of the present invention. FIG. 2A is a perspective view of a handset 210 having a screen 240 therein. FIG. 2B is a perspective view of the handset 210 from FIG. 2B. FIG. 2D is a perspective view of a display device according to a fourth embodiment of the present invention. FIG. 2E is a perspective view of a display device according to a fifth embodiment of the present invention.

As shown in FIGS. 2A and 2B, the screen 240 is installed in an accommodation portion 211 provided in a second folder portion 217 of the handset 210 to be capable of sliding in and out. A projection unit 220 is installed in the first folder portion 214 so that an image can be projected onto the screen 240 when the screen 240 is drawn from the accommodation portion 211. The image is projected through the screen 240 from a rear surface of the first folder portion 214.

A user 260 can instruct the operation of the projection unit 220 and the automatic drawing of the screen 240, through a key operation on a keypad 225. As shown in FIG. 2C, the projection unit 220 enlarges an image and projects an enlarged image onto the screen 240 that is drawn. The user 260 can view the enlarge image on the screen 240 that is larger than a display window 230.

The screen 240 can be accommodated in the accommodation portion 211 by being folded. The screen 240 is formed of a semi-solid material that can be folded and maintain when being drawn out and unfolded. As shown in FIG. 2D, the screen 240 is accommodated in the accommodation portion 211 by being folded along a particular line 242 and unfolded when being drawn from the accommodation portion 211. As shown in FIG. 2E, the screen 240 accommodated in the accommodation portion 211 is by being folded along the particular line 242 can be drawn from the accommodation portion 211 by sliding along a guide portion 290. In this case, the screen 240 can be drawn from the accommodation portion 211 until a side surface 241 of the screen 240 is caught by a protruding portion 291 of the guide portion 290.

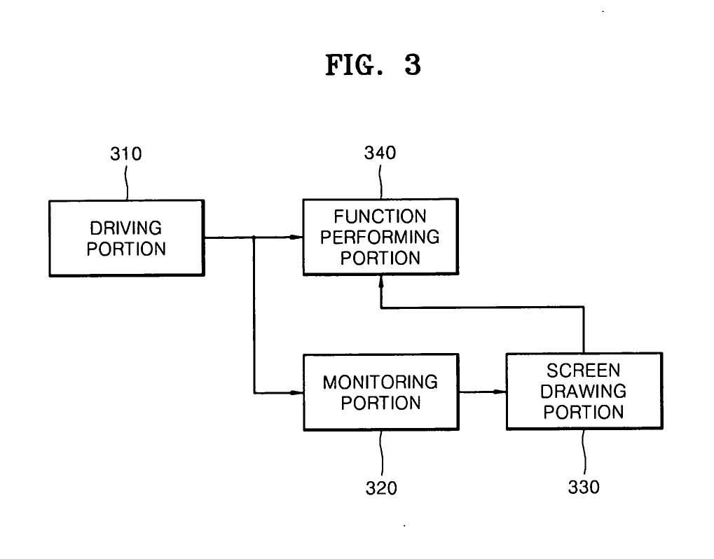

FIG. 3 is a block diagram for explaining a principle of automatic drawing of the screen 114 in accordance with an exemplary embodiment of the present invention. The present display device includes a driving portion 310, a monitoring portion 320, a screen drawing portion 330, and a function performing portion 340.

The driving portion 310 outputs a function performance instruction signal that instruct the handset 210 to perform a predetermined function. The monitoring portion 320 monitors whether the output function performance instruction signal instructs enlargement and projection of an image. The image may be either a motion picture or a still picture.

The screen drawing portion 330 automatically draws the screen 240 from the accommodation portion 211 in response to the result of monitoring by the monitoring portion 320 and generates a screen drawing confirmation signal. That is, when the function performance instruction signal has instructed the enlargement and projection of an image according to the result of monitoring, the screen drawing portion 330 has the screen 240 automatically drawn from the accommodation portion 211. The screen drawing confirmation signal indicates that the screen 240 has been drawn.

The function performing portion 340 enlarges a predetermined image and projects an enlarged image onto the screen 240 that is drawn, in response to the function performance instruction signal and the screen drawing confirmation signal. Consequently, the screen 240 is automatically drawn at a time point when the drawing of the screen 240 is requested, without a need for a user to manually draw the screen 240 each time. The function performance portion 340 includes the projection unit 220.

Alternatively, the monitoring portion 320 may be omitted, in which case, the driving portion 310 outputs a projection instruction signal instructing the handset 210 to enlarge and project a predetermined image. The screen drawing portion 330 draws the screen 240 from the screen accommodation portion 330 according to the projection instruction signal and generates the screen drawing confirmation signal.

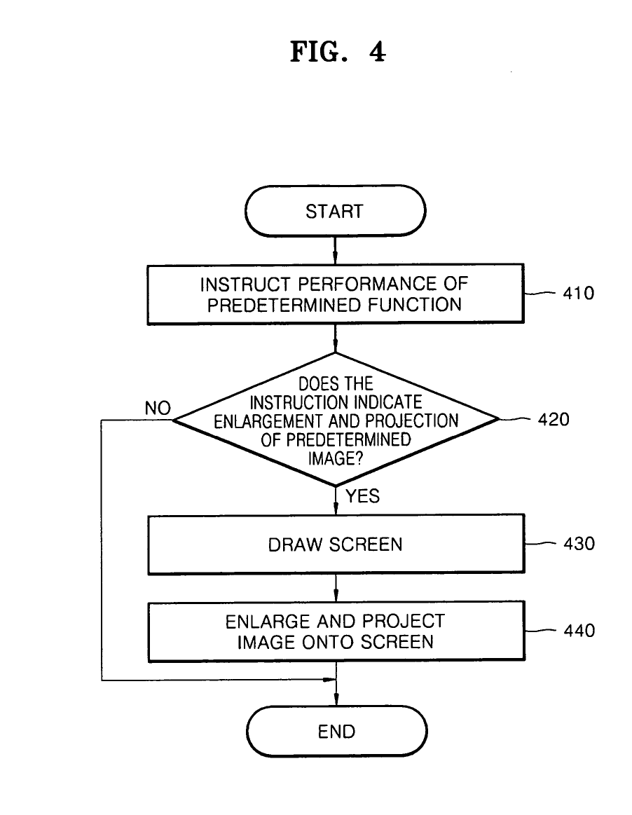

FIG. 4 is a flow chart for explaining the principle of automatic drawing of the screen 240 in accordance with an exemplary embodiment of the present invention. Referring to FIG. 4, an instruction is generated to instruct the performance of a predetermined function (Operation 410). Next, it is determined whether the instruction indicates enlargement and projection of an image (Operation 420). If it is determined that the instruction indicates the enlargement and projection of an image, the screen 240 is drawn (Operation 430), and the image is enlarged and projected onto the screen 240 (Operation 440).

The driving portion 310 instructs the handset 210 to perform a predetermined function (Operation 410). The monitoring portion 320 determines whether the instruction indicates the enlargement and projection of an image (Operation 420). As a result of the above determination, that is, the instruction indicates the enlargement and projection of an image, the screen drawing portion 330 draws the screen 240 from the screen accommodation portion 330 (Operation 430). After Operation 430, the projection unit 220 of the function performing portion 340 the image enlarges the image and projects the enlarged image onto the screen 240 (Operation 440). However, when the instruction does not indicate the enlargement and projection of the image, the display method according to the present invention is not performed.

The invention can also be embodied as computer readable codes on a computer readable recording medium. The computer readable recording medium is any data storage device that can store data which can be thereafter read by a computer system. Examples of the computer readable recording medium may include read-only memory (ROM), random-access memory (RAM), CD-ROMs, magnetic tapes, floppy disks, optical data storage readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

While this invention has been particularly shown and described with reference to exemplary embodiments thereof, it will be understood by those skilled in the art that various changes in form and details may be made therein without departing from the spirit and scope of the invention as defined by the appended claims.

As described above, according to the display device according to the present invention, an image that the handset displays is displayed on the screen that is larger than the display window of the handset. Thus, various contents such as an Internet search or a movie can be viewed through an enlarged screen of a mobile handset with more convenience and sense of liveliness. Also, the display device according to the present invention can enlarge an image and project the enlarged image onto a screen for a long time by using a laser scanning method that exhibits a superior optical efficiency and a low power consumption.

What is claimed is:

1. A display device comprising:
a handset which comprises a display window on which an image is displayed, and a projection unit the which projects image; and
a screen which is movably installed on the handset and displays the image projected thereon by the projection unit.

2. The display device according to claim 1, wherein the image projected on the screen is larger than the image displayed on the display window.

3. The display device according to claim 2, wherein the screen is movable between a first position in which the image is not projected on the screen and a second position in which the image is projected on the screen.

4. The display device according to claim 3, wherein in the first position, the screen is wound into a roll installed at an end surface of the handset, and in the second position, the screen is drawn out from the roll in a planar form.

5. The display device according to claim 4, wherein the screen comprises a hook formed at an end of the screen, and the handset comprises a hole to which the hook is coupled when the screen is in the second position so that the screen faces the projection unit.

6. The display device according to claim 1, wherein the handset comprises a screen accommodation portion in which the screen is accommodated to be capable of sliding in and out.

7. The display device according to claim 6, further comprising:
a driving portion that instructs the handset to generate the image; and
a screen drawing portion that slides the screen out from the screen accommodation portion so that the image may be projected on the screen.

8. The display device according to claim 6, further comprising:
a driving portion that outputs a signal;
a monitoring portion that monitors whether the signal instructs generation of the image; and
a screen drawing portion that slides the screen out from the screen accommodation portion in response to a monitoring result from the monitoring portion.

9. The display device according to claim 1, wherein the handset selectively displays the image on one of the display window and the screen.

10. A display device comprising:
a handset comprising a first folder portion including a display window on which an image is displayed and a second folder portion that folds open and closed with respect to the first folder; and
a screen which is movably installed on the handset and has a size larger than a size of the display window,
wherein one of the first folder portion and the second folder portion includes a projection unit that projects the image onto the screen.

11. The display device according to claim 10, wherein the image projected on the screen is larger than the image displayed on the display window.

12. The display device according to claim 11, wherein the screen is movable between a first position in which the image is not projected on the screen and a second position in which the image is projected on the screen.

13. The display device according to claim 12, wherein in the first position, the screen is wound into a roll installed at an end surface of the second folder, and in the second position, the screen is drawn out from the roll in a planar form.

14. The display device according to claim 13, wherein the screen comprises a hook formed at an end of the screen, and the first folder further comprises a hole to which the hook is coupled when the screen is in the second position so that the screen faces the projection unit.

15. The display device according to claim 10, wherein the second folder comprises a screen accommodation portion in which the screen is installed to be capable of sliding in and out.

16. The display device according to claim 15, wherein the screen is foldable to a folded position in which the image is not projected on the screen and an unfolded position in which the image is projected on the screen.
a driving portion that instructs the handset to generate the image; and
a screen drawing portion that slides the screen out from the screen accommodation portion so that the image is projected on the screen.
